(19) United States
(12) Patent Application Publication
(10) Pub. No.: US 2015/0226539 A1
(43) Pub. Date: Aug. 13, 2015

(54) SYSTEM AND METHOD FOR DETERMINING THE POSITION OF DEFECTS ON OBJECTS, COORDINATE MEASURING UNIT AND COMPUTER PROGRAM FOR COORDINATE MEASURING UNIT

(71) Applicant: KLA-TENCOR CORPORATION, Milpitas, CA (US)

(72) Inventors: Klaus-Dieter ROETH, Solms (DE); Mohammad M. DANESHPANAH, Foster City, CA (US); Alexander BUETTNER, Weilburg (DE); Apo SEZGINER, Monte Sereno, CA (US); Mark WAGNER, Rehovat (IL)

(21) Appl. No.: 14/691,097

(22) Filed: Apr. 20, 2015

Related U.S. Application Data
(63) Continuation of application No. PCT/US2014/037916, filed on May 13, 2014.
(60) Provisional application No. 61/834,987, filed on Jun. 14, 2013.

(51) Int. Cl. G01B 11/00; G01N 21/88

(52) U.S. Cl. CPC G01B 11/005; G01N 21/8806; G01N 2201/06113; G01N 2201/0697; G01N 2201/0691

(57) ABSTRACT

A system, a method and a coordinate measuring machine is disclosed for determining the position of defects on objects. An interface is provided so that alignment and coordinate information from the inspection device can be sent to the coordinate measuring machine. A special illumination and detection arrangement is used with a plurality of optical elements in order to obtain a signal from defects on the unpatterned object. The light source of the illumination and detection arrangement is a laser light source for providing a partially coherent light beam. A computer calculates from the data provides by the detector array and the alignment and coordinate information of the object from the inspection device a position of the defect on the object.

### CROSS-REFERENCE TO RELATED APPLICATIONS

This application is a Continuation of International Patent Application Serial No. PCT/US2014/37916, filed on May 13, 2014, which application claims priority of U.S. Provisional Patent Application No. 61/834,987, filed on Jun. 14, 2013, which applications are incorporated herein by reference.

### FIELD OF THE INVENTION

The present invention relates to a system for determining the position of defects on objects.

The present invention also relates to a method for determining the position of defects on objects.

Additionally, the present invention relates to a coordinate measuring machine for determining the position of defects on objects.

Furthermore, the invention relates to a computer program for a coordinate measuring machine in order to determine a position of at least one defect on an object.

### BACKGROUND OF THE INVENTION

The U.S. Pat. No. 7,903,259 discloses a device for determining the position of a structure on an object in relation to a coordinate system. The object is placed on a measuring table which is movable in one plane, wherein a block defines the plane. At least one optical arrangement is provided for transmitted light illumination and/or reflected light illumination. The optical arrangement comprises an illumination apparatus for reflected light illumination and/or transmitted light illumination.

U.S. Patent Application Publication No. 2013/017475 discloses a light method of high-sensitively detecting both of a phase defect existing in a mask blank and a phase defect remaining after manufacturing a patterned extreme ultraviolet (EUV) mask. By using a dark-field imaging optical system a center shielding portion is used for shielding EUV light and a linear shielding portion for shielding the EUV light whose width is smaller than a diameter of the center shielding portion. There is no disclosure that the position of a defect on an EUV mask is measured.

The International Patent Application WO2010/148293 discloses an inspection of EUV patterned masks, blank masks, and patterned wafers generated by EUV patterned masks. This requires a high magnification and a large field of view at the image plane. An EUV inspection system includes a light source directed to an inspected surface, a detector for detecting light deflected from the inspected surface, and an optical configuration for directing the light from the inspected surface to the detector. In particular, the detector can include a plurality of sensor modules. Additionally, the optic configuration can include a plurality of mirrors that provide magnification of at least 100× within an optical path less than 5 meters long.

U.S. Patent Application Publication No. 2011/181868 provides inspection methods and systems for inspecting objects, such as EUV mask blanks, for surface defects, including extremely small defects. Defects may include various phase objects, such as bumps and pits that are only about 1 nanometer in height, and small particles. Inspection is performed at wavelengths less than about 250 nanometers, such as a reconfigured deep UV inspection system. A partial coherence sigma is set to between about 0.15 and 0.5. Phase defects can be found by using one or more defocused inspection passes, for example at one positive depth of focus and one negative depth of focus. In certain embodiments, depth of focus is between about −1 to −3 and/or +1 to +3. The results of multiple inspection passes can be combined to differentiate defect types. Inspection methods may involve applying matched filters, thresholds, and/or correction factors in order to improve a signal to noise ratio.

The standard method, as disclosed above, is to use an inspection system to detect and locate the phase defects. The limitation of current inspection systems is that the inspection systems are designed for high speed applications and do not have the accurate stage interferometer and environmental control required for sub-30 nm defect location accuracy. Phase defects can be detected by state-of-the-art reticle inspections systems (e.g. the TERON 630 product sold by KLA Tencor Corp.), however these systems cannot provide accurate enough position information in order to use the above mentioned software and higher (<30 nm) defect location accuracy is requested from leading customers.

EUV masks (unpatterned objects) need to be manufactured with zero defects. However, the difficulty of EUV mask manufacture has compelled the industry to look for compromise solutions by which some yield limiting phase defects will be accepted. To mitigate the effect of these phase defects, software has been developed by various suppliers to avoid putting critical structures at the location of a phase defect. This software is only feasible if the location of all detected phase defects is well known with an accuracy of 30 nm or less.

### BRIEF SUMMARY OF THE INVENTION

It is an object of the invention to provide a system to measure the location of phase defects on objects, especially EUV mask blanks, with very high accuracy, wherein the accuracy should allow a determination of phase defect positions with an uncertainty of less than 30 nm.

The object is achieved by a system for determining the position of defects on objects including an apparatus with a coordinate measuring unit and an inspection unit for objects and an interface for sending alignment and coordinate information from the inspection unit to the coordinate measuring unit machine.

A further object of the invention is to provide a method for measuring the location of phase defects on objects, especially EUV mask blanks, with very high accuracy, wherein the accuracy should be such that a determination of phase defect positions is with an uncertainty of less than 30 nm.

The object is achieved by a method for determining the position of defects on objects including the following steps transferring alignment and coordinate information of at least one defect taken by an inspection unit of an apparatus to a coordinate measuring unit of an apparatus, generating an illuminating light beam for the coordinate measuring unit, having a wavelength of less than about 300 nanometers, positioning a measurement stage of the coordinate measuring machine according to the alignment and coordinate information transferred by an inspection device, illuminating the object with the illuminating light beam through a set of optical elements, setting at least various defocus positions of a measuring objective along a Z coordinate direction and acquiring a data set at each Z-position with a detector array of a camera, determining a phase defect from the acquired data set at certain defocus positions, wherein the data set is filtered, and measuring the position of the phase defect by measuring the position of the stage in the X-coordinate direction and the Y coordinate direction at high accuracy and high sampling rate through a length gauge.

An additional object of the present invention is to provide a coordinate measuring machine adapted to measure the location of phase defects on objects, especially EUV mask blanks, with very high accuracy, wherein accuracy should allow a measurement of the phase defect positions with an uncertainty of less than 30 nm.

The above object is achieved by a coordinate measuring machine include a measuring stage for moving the object in a X-coordinate direction and a Y-coordinate direction and being equipped with a length gauge for measuring the position of a phase defect by measuring the position of the stage in the X-coordinate direction and the Y coordinate direction at high accuracy and high sampling rate, an illumination and detection arrangement having a light source for reflected light illumination of the object, a measuring objective and a detector array arranged for detecting an intensity of light reflected from the object and collected by the measuring objective, a shifting device for moving the measuring objective along a Z coordinate direction in order to set different focus positions, and a computer, for receiving a set of image data from the detector array of at least one defect taken at various focus positions and for determining the image data set from the various focus positions which is suitable for measuring a position of the defect on the object in the X-coordinate direction and the Y-coordinate direction.

An additional object of the invention is to provide a computer program for a coordinate measuring machine which allows the measurement of locations of phase defects on objects, especially EUV mask blanks, with very high accuracy, wherein the accuracy should be such that a determination of phase defect positions is with an uncertainty of less than 30 nm.

The above object is achieved by a computer program for a coordinate measuring machine including setting the measurement objective to at least one defocus position with respect to an object, at least one image taken by a detector array at the at least one defocus position, wherein each image is composed of a plurality of pixels each providing an intensity signal I(x,y,f) at the at least one defocus position, applying a filter, providing a filtered output image data set w(X,Y) of the least one defocus position, detecting at last one defect at a location X, Y on the object, if |w(X,Y)| exceeds a predetermined threshold, and measuring a position of the at least one defect through a double-pass interferometer means which is in a known relation with a measuring stage of the coordinate measuring machine.

The coordinate measuring unit must carry out three steps. Firstly, redetection of the defect detected by the inspection unit. Secondly, it is necessary to calculate some geometric parameters of the defect, for example, center of gravity. Thirdly, the determination of the accurate location of the center of gravity is carried out. This “matched-filter method” is the preferred approach. Other embodiments of a filter may be employed as well, depending on the nature of the defect signal.

There is another embodiment of the defect detection algorithm. The defect detection can be based on the statistics of the defect signal. During a ‘training’ stage a reference object (EUV mask blank) has several implanted and known phase defects. During a training stage a probability distribution function (PDF) of the defect signal I_{training}(x,y,f) is determined Hypothesis testing (or other statistical methods) with a certain threshold can be used to detect the defective pixel or pixels from the Iₘₑₐₛᵤᵣₑₘₑₙₜ(x,y,f) data based on the learnt defect PDF.

According to one possible embodiment, the inspection unit and coordinate measuring unit could be incorporated in the same and single apparatus with two different imaging/detection modes. An inspection mode—fast enough to cover the whole substrate (mask), detect the defects, but with limited coordinate accuracy. A metrology mode—redetect the location or position of defects with sub-30 nm coordinate accuracy.

The inventive system comprises an apparatus with a coordinate measuring unit and an inspection unit for objects, which are for example EUV mask blanks. The coordinate measuring unit and the inspection unit share the acquired data via an internal interface in order to receive alignment and coordinate information from the inspection unit. Inspection units are designed for high speed and do not have the accurate stage length gauge and the environmental control required for sub-30 nm defect location accuracy. According to one embodiment the system has in one single apparatus a coordinate measuring unit and an inspection unit. In this case the apparatus has a stage which fulfills the accuracy requirements of a coordinate measuring unit and the inspection unit. The system is adapted to inspect and determine the position of the center of gravity of defects on patterned and/or unpatterned objects.

According to a further embodiment of the invention the apparatus comprises a coordinate measuring unit which is locally separated from the inspection unit. In this case the inspection unit does not need to have the accurate stage length gauge and the environmental control required for sub-30 nm defect location accuracy. Therefore the coordinate measuring unit can use the alignment and coordinate information from the inspection unit in order to move the measurement stage quickly to the location of a defect on the substrate detected by the inspection unit and carry out the process steps for the measurement of the defect location or the determination of the location of the center of gravity of the defect with the required accuracy. The embodiment described here, has an inspection unit and a coordinate measuring unit, which operate sequentially. The information is restricted to flow from the inspection unit to the coordinate measuring unit. The system is adapted to inspect and determine the position of the center of gravity of defects on patterned and/or unpatterned objects.

The coordinate measuring unit, regardless if embodied as a single apparatus with an inspection unit or as two locally separated units, has a measuring stage for moving the object in a X-coordinate direction and a Y-coordinate direction. An illumination and detection arrangement of the coordinate measuring unit is equipped with a light source for reflected light illumination of the object. A measuring objective and a detector array are arranged for detecting an intensity of light reflected from the object and collected by the measuring objective. A shifting device is provided for moving the measuring objective along a Z coordinate direction in order to set different focus positions. With the detector array at least one data set is captured per focus position. A computer is provided for receiving the data set from the detector array of at least one defect on the object at various focus positions. Additionally, the computer receives the alignment and coordinate information from the inspection device. Finally, with the computer a position of the defect on the object is calculated by the use of all the information and data generated.

The light source of the illumination and detection arrangement is a laser light source. The laser light source provides a light beam to illuminate the object with partially coherent light. It is evident for a person skilled in the art that the laser light can be unpolarized or polarized. In case the laser light is polarized it can be either circularly polarized or linearly polarized. According to one embodiment the laser light source is a pulsed laser light source and the detector array is a CCD—sensor for mitigating the effect of vibration and unwanted blur. The laser light source could be as well a continuous wave laser light source and the detector could be a CCD-sensor or a TDI-sensor. The laser light source could be a pulsed laser light source and the detector could be as well a CCD-sensor or a TDI-sensor. In case the detector array is a TDI-sensor a continuous integration results in a higher signal to noise ratio.

The illumination and detection arrangement has an illumination pupil which provides low-sigma illumination setup in which sigma is smaller than 0.25. The illumination and detection arrangement includes the measurement objective and the tube lens. Unlike inspection systems where focus offset is of secondary importance, a registration metrology system needs to obtain accurate focus or defocus information at each point on the object (mask). To achieve this, the measurement object uses a focus-offset generator module which allows splitting the imaging field into a mosaic of images at different focus offsets. The contrast/signal-to-noise ratio of the defect signal may be increased by adding special amplitude and/or phase filters into the illumination and/or imaging pupil. In this way it could be possible to increase the accuracy of the defect location and/or to reduce the detectable defect size. Furthermore, the illumination and detection arrangement has a first beam splitter which directs light from the light source through the illumination pupil, via the measuring objective onto the object. With a second beam splitter reflected light from the object is directed via an imaging pupil and a tube lens onto the detector.

A climate chamber surrounds at least the coordinate measuring unit in order to control environmental parameters such as temperature, pressure and air turbulence. Changes in the environmental parameters can affect the imaging conditions and the stage position measurement contaminating the registration or position measurements. It is clear for a skilled person that the position measurement of the measuring stage can be carried out with several conventional length gauge methods. One possible method uses a double pass interferometer. Traditional registration metrology tools employ a tightly controlled chamber to within a few milli-kelvins to stabilize the measurement.

The computer has an algorithm implemented for calculating intensity values of a pixel position. A plurality of data sets is taken by the measuring objective at various focus positions along the Z coordinate direction. The defect signature is distributed among all focal planes. Depending on defect shape and size, the signal-to noise ratio changes across foci. Also, filtering precedes detection in general. The phase defect provides a signal (data set) at the various defocus positions which has to be detected and filtered. Capturing the data set, which could be displayed to a user as images, at various defocus positions may result in signal-to-noise enhancement leading to measurement capability on smaller (Smaller SEVD=spherical equivalent volume diameter) defects.

The coordinate measuring unit has a measuring stage for moving the object in a X-coordinate direction and a Y-coordinate direction. The exact position of the measuring stage is determined with a length gauge. According to one possible embodiment of the invention the length gauge could be a double-pass interferometer means. Another embodiment for a possible length gauge would be a glass scale. The illumination and detection arrangement has at least a light source for reflected light illumination of the object, a measuring objective and a detector array arranged for detecting an intensity of light reflected from the object and collected by the measuring objective. The different defocus positions are achieved by the shifting device which moves the measuring objective along the Z coordinate direction. The computer of the coordinate measuring unit takes various functions. The main aspect of the computer is the execution of an algorithm which allows the measurement of a position of at least one defect on the object in the X-coordinate direction and the Y-coordinate direction. The position of the defect is referred to a coordinate system on the object.

The coordinate measurement unit has an interface, which communicates with the computer, for receiving alignment and coordinate information from the inspection unit. The measuring stage provides means to scan the object at variable speeds and is capable of synchronizing with the laser pulses and/or the detector array. The position of the stage is measured at high accuracy and high sampling rate according to one embodiment of the invention through a double-pass interferometer where a wavelength correction system (Etalon) is used to correct for changes in the air refractive index.

The inventive method is carried out with a coordinate measuring unit in order to determine defects on patterned or unpatterned objects (EUV-mask blanks). Alignment and coordinate information of at least one defect are transferred from the inspection device to the coordinate measuring machine. A light beam is generated, having a wavelength of less than about 300 nanometers. Through a set of optical elements the light beam is directed onto the object and from the unpatterned object to the detector array. The set of optical elements comprises a measuring objective which is movable in a Z-coordinate direction for setting a desired defocus position. The detector array is arranged for detecting the intensity of light reflected from the object and collected by the measuring objective. A first beam splitter directs light from the light source via the measuring objective onto the object. A second beam splitter directs reflected light from unpatterned object via an imaging pupil and a tube lens onto the detector array.

The inventive method uses an algorithm in order to calculate a center of gravity from at least one data set, captured at various defocus positions, to redetect a defect on the patterned or unpatterned substrate. The data set or the image data are captured by the detector array. There is an additional step of characterizing the geometry of the defect, for example calculating center of gravity. The position of the identified defect is then measured with the coordinate measuring unit. The algorithm calculates from the intensity values I(x,y) for all pixel positions of an image which include the defect and from the plurality of images taken by the detector array, wherein for each image the measuring objective being positioned at a different focus position along the Z coordinate direction. From the different data sets or stack of images at the different defocus positions, at least one data set or at least one image of the defect at various defocus positions is obtained. The data sets or images allow the measurement of the position and dimension of the defect on the patterned or unpatterned object. According to a more general embodiment of the invention, the defect signature is re-detected in the focal stack of data sets or images (matched filter in 3D), where all data sets or images contribute to the defect signal.

The computer program carries out the measurement process of the defect as well. At least one image is taken or at least one data set is captured by the detector array at the at least one defocus position. From the plurality of data sets or images a derivate data set or image is calculated. The derivate image or derivate data set is composed of a plurality of pixels each providing an intensity signal I(x,y,f) at the at least one defocus position f. From the derivate data set or image a center of gravity is determined, which is used to determine the position of the defect with the coordinate measuring unit. Then an applied function provides an altered output image data set w(X,Y) of the least one defocus position. The altered output image data set w(X,Y) allows the detection of at least one defect at a location X, Y on the object. A defect is detected if |w(X,Y)| exceeds a predetermined threshold. Once the defect is detected the position of the defect is measured with the coordinate measuring machine. There is a defined relation between the coordinate system of the coordinate measuring unit, the coordinate system of the measuring stage and the coordinate system of the object. With this relation it is possible to obtain the position of the defect on the object with the required accuracy.

According to one embodiment of the present invention the function is a filter.

In an alternative embodiment of the computer program the function is a probability distribution function. The probability distribution function is determined during a training stage of a reference object which has several implanted and known phase defects. The defects on an object to be inspected are detected on the object with a statistical method based on the learnt probability distribution function. The statistical method could be a hypothesis testing.

The novel position measuring method described herein can be used for the determination of positions of defects on objects, especially EUV mask blanks, and other semiconductor components. In a specific example, a multilayer EUV mask blank is measured for the position of phase defects, such as bumps and pits, using a specifically configured deep ultraviolet (DUV) mask metrology system. In other words, these techniques meet metrology goals of 22 nanometer and below half-pitch (hp) nodes and could be performed at a better throughput. A coordinate measuring machine is configured with a partial coherence sigma of between about 0.15 and 0.5. Reflected light may be captured with a detector and passed to a computer system for analysis. A signal to noise ratio (SNR) can be improved by applying specially designed filters, thresholds, and correction factors.

One advantage of the inventive approach is the possibility to measure a position of phase defects accurately in the 10-30 nm range with respect to a given coordinate system on the EUV mask blank. An important aspect of the invention is the through focus scanning of phase defects and the subsequent filtering of the images to achieve a signal on a coordinate measuring machine, suitable to measure defect location. Furthermore a modified illumination (low sigma) on a coordinate measuring machine is needed, which possibly includes special amplitude/phase filters in the illumination and imaging pupil. Finally, it includes the development of an algorithm for through focus scanning microscope to detect phase defects.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

The nature and mode of operation of the present invention will now be more fully described in the following detailed description of the invention taken with the accompanying figures, in which:

FIG. 1 is a side view schematic representation of an EUV mask blank exemplifying various types of defects on the surface;

FIG. 1A is a side view schematic representation of an EUV mask blank, wherein the substrate has a bump;

FIG. 1B is a side view schematic representation of an EUV mask blank wherein the substrate has a pit;

FIG. 2 is a side view schematic illustration of a surface of an EUV mask blank exemplifying detection of two types of phase-defects in accordance with certain embodiments;

FIG. 3 illustrates four simulated images of the optical system point spread function at a focal point and a certain defocused point and shown as an in-phase central spot and out-of-phase 90° ring;

FIG. 4 is an illustrative plot of contrast as a function of focal point position for two types of phase defects;

FIG. 5 is a schematic representation of a system comprising a coordinate measuring machine and an inspection device;

FIG. 6 is a schematic representation of a climate chamber for the coordinate measuring machine;

FIG. 7 is a schematic representation of a coordinate measuring machine with which the measurement of positions of defects on an EUV mask blank are carried out;

FIG. 8 is a schematic representation of the illumination system used in the coordinate measuring machine for determining positions of defects on EUV-masks; and,

FIG. 9 is a flow chart of the inventive method to determine the location of a defect on an object.

### DETAILED DESCRIPTION OF THE INVENTION

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

Identical reference numerals refer to the same elements throughout the various figures. Furthermore, only reference numerals necessary for the description of the respective figure are shown in the figures. The shown embodiments represent only examples of how the invention can be carried out. This should not be regarded as limiting the invention.

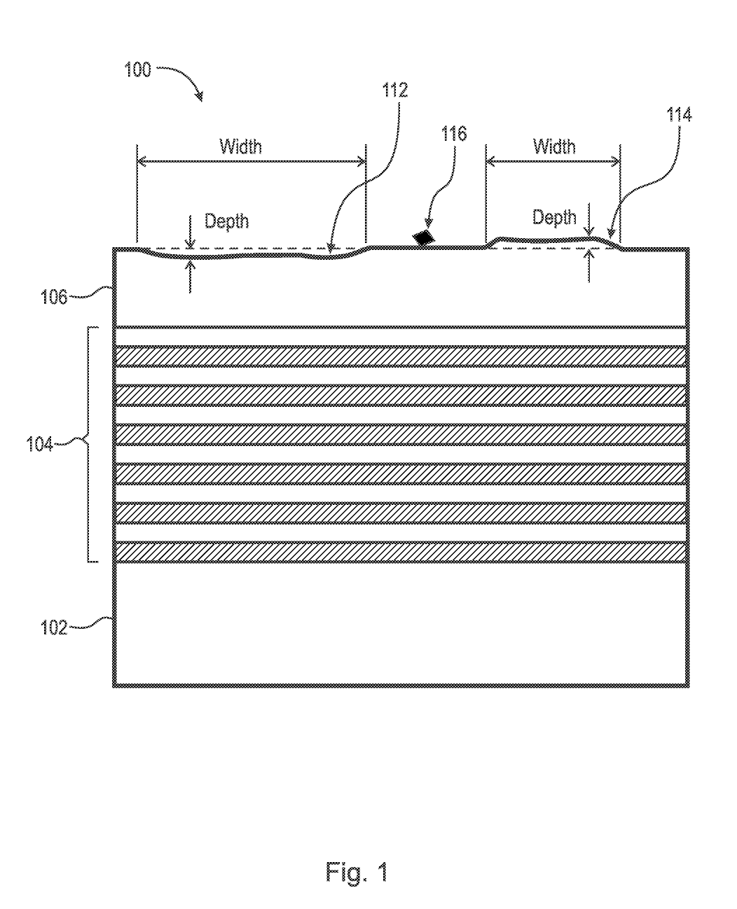

FIG. 1 is a side view schematic representation of an unpatterned object 100, which is a EUV mask blank. A EUV mask blank 100 typically includes a substrate 102, such a low thermal expansion (LTE) glass sheet. The substrate is covered with multiple layers 104 of materials to provide good reflectance at the EUV wavelength for doing lithographic exposure. In certain embodiments, the multiple layers 104 include 30-40 iterating pairs of molybdenum (Mo) and silicon (Si) layers arranged with about 7 nanometer pitch. The multiple layers 104 may include a capping layer 106. In other embodiments, a sample may include quartz, antireflective coating (ARC), and other features.

EUV mask blanks 100 and other sample sometimes have surface defects 112, 114 or 116. The defects 112, 114 or 116 can be generally characterized as phase defects, such as pit 112 and bump 114, and particles 116. These bumps and pits usually arise from defects at the substrate 102. Thus, the layers 104 are typically also distorted. While bumps 114 and pits 112 are almost purely optical phase objects, particles 116 have both amplitude and phase characteristics. Both types of defects can be very damaging to EUV lithography and need to be carefully screened for. For example, a phase shift caused by a 1 nanometer bump is sufficient to produce a printable defect.

FIG. 1A is a side view schematic representation of an EUV mask blank 100, wherein the substrate 102 has a bump 114S. On top of the substrate 102 and as well of the bump 114S a plurality of the layers 104 are deposited. On top of the layers 104 a capping layer 106 is formed. The bump 114S on the substrate 102 results in a bump 114 on the surface of the capping layer 106. The bump 114 on the surface of the capping layer 106 has a height H and a width W, which is larger than the width of the bump 114S on the substrate 102.

FIG. 1B is a side view schematic representation of an EUV mask blank 100, wherein the substrate 102 has a pit 112S. On top of the substrate 102 and as well of the pit 112S a plurality of the layers 104 are deposited. On top of the layers 104 a capping layer 106 is formed. The pit 112S on the substrate 102 results in a pit 112 on the surface of the capping layer 106. The pit 112 on the surface of the capping layer 106 has a depth D and a width W, which is smaller than the width of the pit 112S on the substrate 102.

Actinic (e.g., 13.5 nanometers) inspection tools can be used for inspection of these defects, but these tools are not expected to be available for several years in high throughput configurations suitable for non-academic uses. Currently available systems have either throughput or sensitivity limitations. For example, multi-beam confocal microscopes supplied by LaserTec in Yokohama, Japan detect surface disturbances by monitoring reflective signals. However, these microscopes have a poor sensitivity and are generally not suitable for inspection of EUV mask blank defects. Higher illumination powers could improve the sensitivity but they are often damaging to EUV mask blanks. Dark-field 13.5 nanometer microscopes have been proposed for EUV mask blank inspection, but these dark-field systems can be extremely slow and may not be suitable for production uses.

It has been found that a DUV inspection system can be configured for inspection of small surface defects on EUV mask blanks and other similar samples. In accordance with a specific embodiment, the Teron 600 inspection system, available from KLA Tencor in Milpitas, Calif., has been reconfigured for inspection phase defects as small as 1 nanometer in height and 80 nanometers FWHM on typical EUV mask blanks. Inspection results were compared to those obtained from an actinic Advanced Inspection Tool at Lawrence Berkeley National Laboratory in Berkeley, Calif. and found to be consistent between the two inspection systems. Some experimental results are described in more details below. It has been also found that DUV systems can be also configured for inspecting particle defects.

Optical inspection principles will now be briefly explained in order to provide a context for various defect detection techniques proposed herein. Dark field detection involves collection and analysis of scattered radiation from the surface. This technique is sensitive to small defects, such as particles and sharp edges. But some surface topography, such as large shallow defects, and some crystallographic defects, such as slip lines and stacking faults, may not scatter light efficiently. Bright field detection refers to collection and analysis of reflected radiation from the surface. This technique is sensitive to variations (e.g., slope) over the inspected surface. Various aspects of reflected light in the bright field detection may reveal useful information about the surface. For example, an intensity of the reflected light may reveal surface material information. A phase and direction of the reflected light may on the other hand also reveal surface topography and material information.

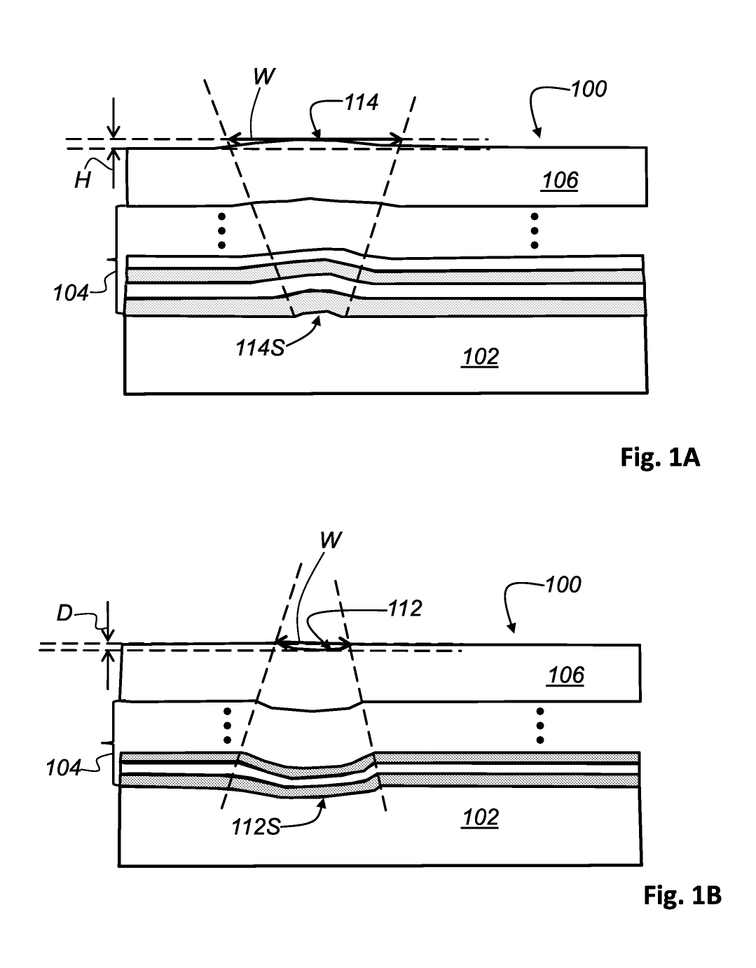

FIG. 2 is a side view schematic illustration of a EUV-mask blank surface exemplifying an inspection of two types of phase defects in accordance with certain embodiments. A substantially flat portion 202 of the inspected surface is shown as a reference to illustrate phase shift differences in the light beams reflected from the pit 204 and the bump 206. It should be noted that a surface roughness produces some additional phase fluctuations, which become a part of the overall background noise. A surface roughness is generally consistent across the entire sample surface, which includes both flat portions (such as element 202) as well defects (such as elements 204 and 206). As such, a roughness can be at least partially compensated for by applying a specifically designed filter. Such filter could substantially increase a signal to noise ratio.

When the pit 204 is inspected, the reflected light 210 has the same amplitude as the reflected light 212 from the flat portion 202. However, the reflected light 210 from the pit 204 has a negative phase difference when compared to the reflected light 212 from flat surface. Likewise, when the bump 206 is inspected, the reflected light 211 from the bump 206 has the same amplitude, but it now has a positive phase difference when compared to the reflected light 212 from the flat surface. In certain embodiments, a portion of the inspected surface or the entire surface can be used as a phase value reference in order to determine phase shifts.

An optical amplitude D for laterally small defects can be expressed with the following formula:

D=exp(iφ) S=1

A phase φ corresponds to the mean defect phase integrated over a point spread function. An optical amplitude S of the flat surroundings is set to one. An image contrast can be achieved by mixing multiple optical amplitudes using a point spread function. Thus, the defect intensity contrast can be expressed with the following formula:

$$Contrast \approx {\vert S \vert}^{2} - {\vert \frac{S + D}{2} \vert}^{2} = - \frac{1}{2} [ 1 - cos ( φ ) ] = - \frac{1}{2} {sin}^{2} ( φ / 2 ) ≅ - \frac{{φ}^{2}}{8}$$

For small phase values φ, the sinusoidal function can be approximated as a linear function.

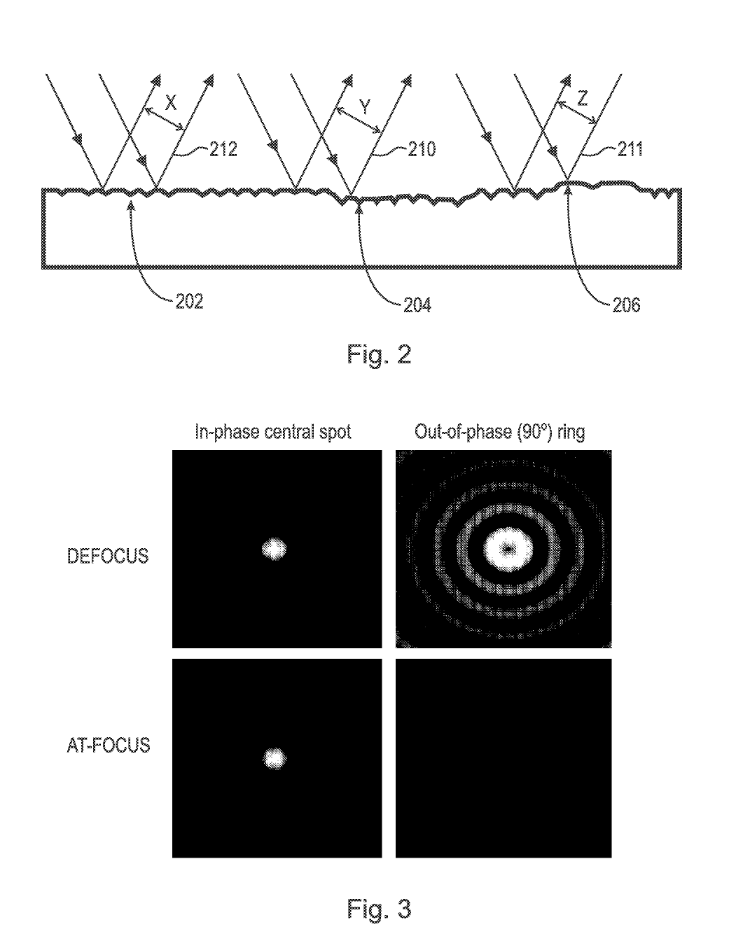

However, a contrast value is relatively small for shallow defects. In order to increase the contrast, an illuminating light beam can be defocused to shift the relative phases of the flat surroundings S and defect D. At a focus (depth of focus (DOF) about equal to 0), the point spread function has only a real part. However, under defocus conditions (DOF<0 or DOF>0), the point spread function has an imaginary part that corresponds to a ring shape. This phenomena is illustrated in FIG. 3, which has four simulated images of the optical point spread function at a focal point and a certain defocused point. The images were captured as both an in-phase central spot and an out-of-phase (90°) ring. In other words, the image contrast can be achieved by mixing of a central spot and a ring, which are 90° out of phase with respect to each other. As such, the contrast can be expressed with the following formula:

$$Contrast \approx {\vert S \vert}^{2} - {\vert \frac{S + iD}{\sqrt{2}} \vert}^{2} = sin ( φ ) \approx φ$$

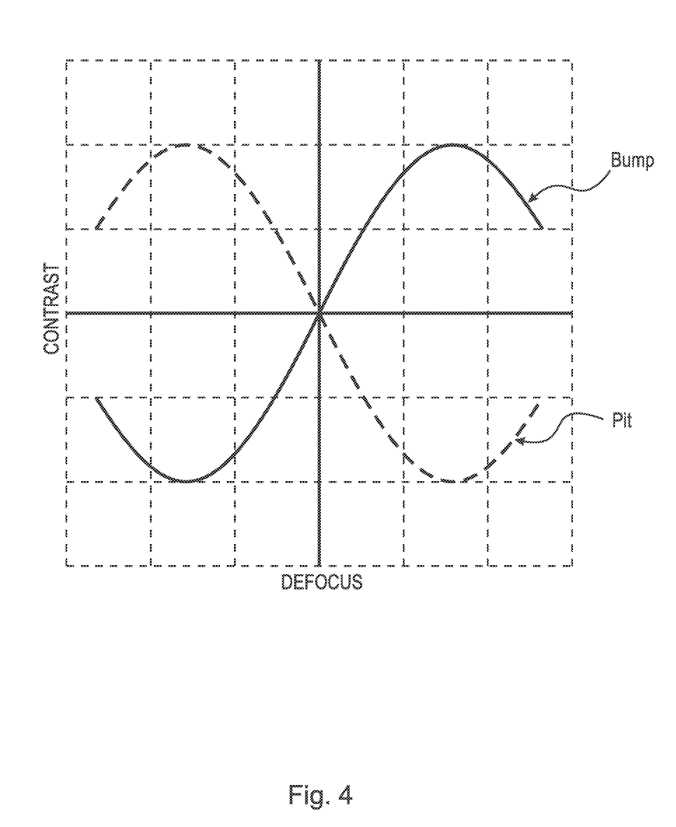

In this last contrast expression, the contrast value is linearly proportional to the phase value φ for small phase values. Bumps and pits will have opposite contrast signs, and the contrast sign will flip when switching from positive to negative defocus values. FIG. 4 illustrates a plot of a contrast as a function of a focal point position, i.e., defocus values, for two types of phase defects. One defect is a bump extending above the surface and another defect is a pit protruding below the surface. Both types of defects are shown to have the same dimensions, e.g., 1 nanometer in height and about 70 nanometers in FWHM, and inspected using the same systems, e.g., a DUV inspection system. A contrast is nearly zero at focus, i.e., defocus value ˜0. Therefore, phase defects are inspected using one or more defocused positions (defocus value <0 or defocus value >0). When multiple inspection passes are performed and/or multiple beams used in the same pass, multiple defocused settings may be used. For example, a combination of positive and negative defocus values may be used. In the same or other embodiments, a combination of defocused (defocus value <0 or defocus value >0) and focused positions (defocus value ˜0) may be used. Focused positions may be used, for example, to detect particles as further explained below.

Unlike phase defects, particles have different optical properties. Particles scatter more light outside of the imaging aperture and are considered to be both amplitude and phase objects. Furthermore, particles are generally larger than typical phase defects or, more specifically, than a typical height of EUV mask blank phase defects. Therefore, different defocus values are often needed for particle detection than for phase defect defection. More specifically, being mostly “amplitude objects”, particles are best detected near focus (defocus value ˜0). However, particles can still provide significant modulation even at defocused conditions.

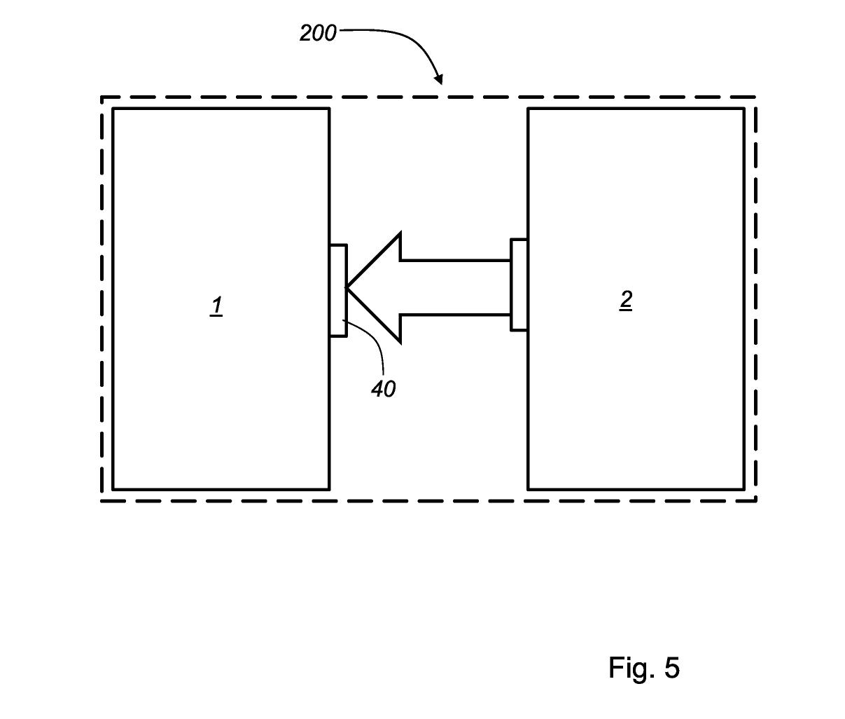

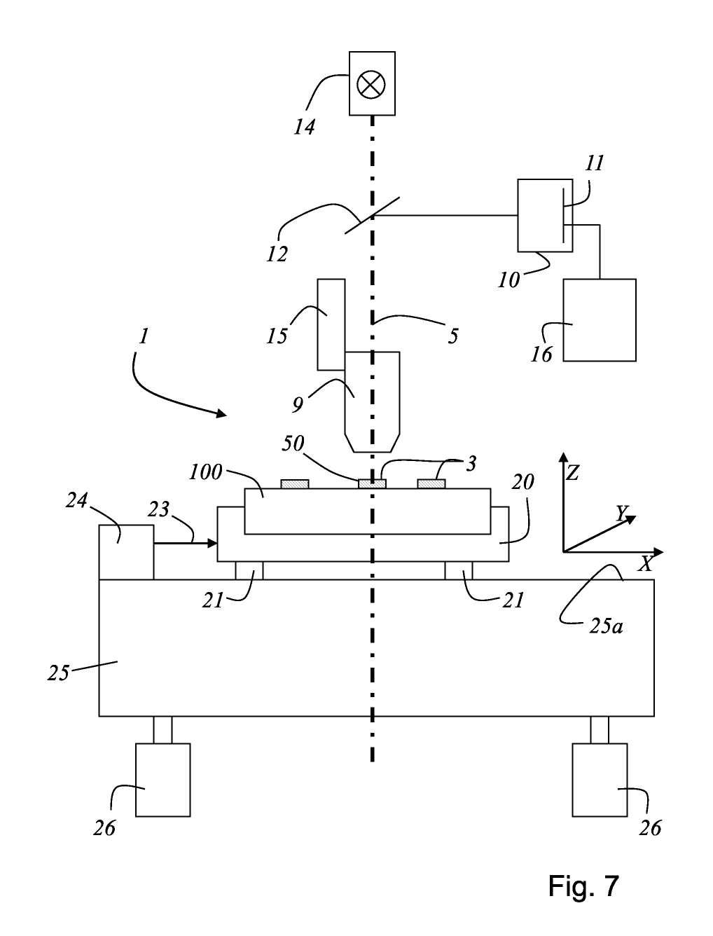

FIG. 5 is a schematic representation of system 200 with a coordinate measuring unit 1 and an inspection unit 2. Via an interface 40 the coordinate measuring unit 1 receives alignment and coordinate information from the inspection unit 2. The inspection unit 2 is used to obtain a rough overview about the alignment and coordinate information of defects on the unpatterned object 100 (see FIGS. 1 and 7). The embodiment shown here, describes a coordinate measuring unit 1 as a coordinate measuring machine and the inspection unit 2 as an inspection device. The embodiment of the invention, shown here is that the coordinate measuring unit 1 and the inspection unit 2 are realized with one single apparatus. The dashed line around the coordinate measuring unit 1 and the inspection unit 2 emphasize that the coordinate measuring unit 1 and the inspection unit 2 are a single apparatus. The interface 40 enables data communication between coordinate measuring unit 1 and the inspection unit 2. According to another embodiment of the invention the coordinate measuring unit 1 and the inspection unit 2 are locally separated apparatuses which communicate via the interface 40.

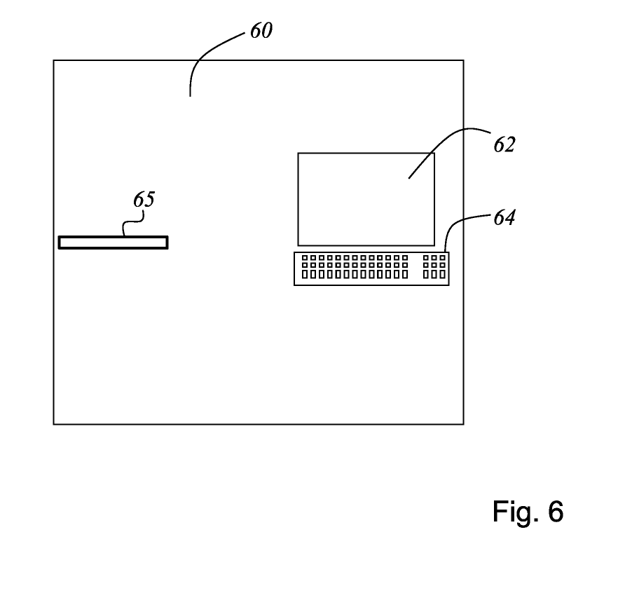

FIG. 6 is a schematic representation of a climate chamber 60 for the coordinate measuring unit 1 or the coordinate measuring machine. Changes in the environmental parameters, such as temperature, pressure and air turbulence can affect the imaging conditions and the position measurement of measuring stage 20 (see FIG. 7). All in all the registration (position) measurements are contaminated. Usually, a coordinate measuring unit 1 employs a tightly controlled climate chamber 60 to within a few milli-kelvins to stabilize the measurement of the location of a defect on an unpatterned substrate. On the outside of the climate chamber 60 at least a display 62 and an input unit 64 are provided. Via the display 62 the user receives visual information from the coordinate measuring unit 1. Additionally, the user can provide input information to the coordinate measuring unit 1 via the input unit 64 and control the input via the display 62. Preferably, the input unit 64 is a computer keyboard. The climate chamber 60 has a load port 65 for loading the EUV mask blank into the climate chamber 60.

FIG. 7 schematically shows a coordinate measuring machine 1, as it is used according to the method according to the invention. The coordinate measuring machine 1 has a measuring stage 20, which carries patterned or an unpatterned object which is a EUV-mask blank 100. Likewise it is possible that the measuring stage 20 carries a EUV-mask blank 100, which may be inserted in a mask holder (not shown). The measuring stage 20 is a mirror element in case a laser interferometer system 24 is used for the determination of the position of the measuring stage 20. The position of the measuring stage 20 is determined via a length gauge, which could be the laser interferometer system 24 or a glass scale. The measuring stage 20 is movable on bearings 21 in X and Y directions. In a preferred embodiment, the bearings 21 are as air bearings. The measuring stage 20 rests on a block 25, which defines a plane 25a. The block 25 is preferably made of granite. The position in the X coordinate direction X of the measuring stage 20 is determined, by the laser interferometer system 24. For this purpose, the laser interferometer system 24 emits a measuring light beam 23. The block 25 is positioned on vibration absorbers 26. It is obvious for a skilled person that the provided plane 25a, in which the measuring stage 20 can be moved, can be made from any other material. The block 25 being made of granite shall be regarded by no means as limiting the invention.

The EUV-mask blank 100 can have various types of defects 3 (see description of FIG. 1), whose position is to be measured with reference to a coordinate system. A light source 14 is provided for reflected light illumination. The light source 14 for reflected light illumination emits light into a reflected light beam path 5. The light from the light source 14 for reflected light illumination reaches the EUV-mask blank 100 via a measuring objective 9.

The light source 14 for reflected light illumination is a pulsed laser source or continuous light wave, wherein the type of the used laser light source is based on the applied scanning architecture. The light from the laser light source emits a light beam to illuminate the EUV-mask blank 100 with partially coherent light. A low sigma (<0.25) illumination setup in reflected light is required).

The measuring objective 9 of the coordinate measuring unit 1 can be moved with a shifting device 15 in a Z coordinate direction Z in order to set various focus positions. In the reflected light beam path 5 a decoupling device 12 is provided which directs the light emitted from the EUV-mask 2 and collected by objective 9 onto a camera 10, wherein said camera 10 has a detector 11. The detector 11 is connected with a computer 16 which determines from an intensity image of each defect 3 the X/Y-position of the defect 3 in the coordinate system of the EUV-mask blank 100. In an embodiment of the invention, the light source 14, illumination optics, collection/measuring objective 9, tube lens and detector 11 of the coordinate measuring unit are shared by the inspection unit.

The detector 11 is a detector array, wherein the kind of detector 11 is determined in the relation with the other subsystems including laser light source. The detector array 11 can be either TDI or CCD based detector array 11. The TDI has the advantage of continuous integration hence building a higher SNR, while suffering from blur. The CCD detector array in conjunction with a pulsed laser mitigates the effect of vibration and unwanted blur with the trade-off between throughput and SNR. A variable speed measuring stage 20 with an adaptive laser repetition rate ensures that enough SNR is built up at through-focus data set.

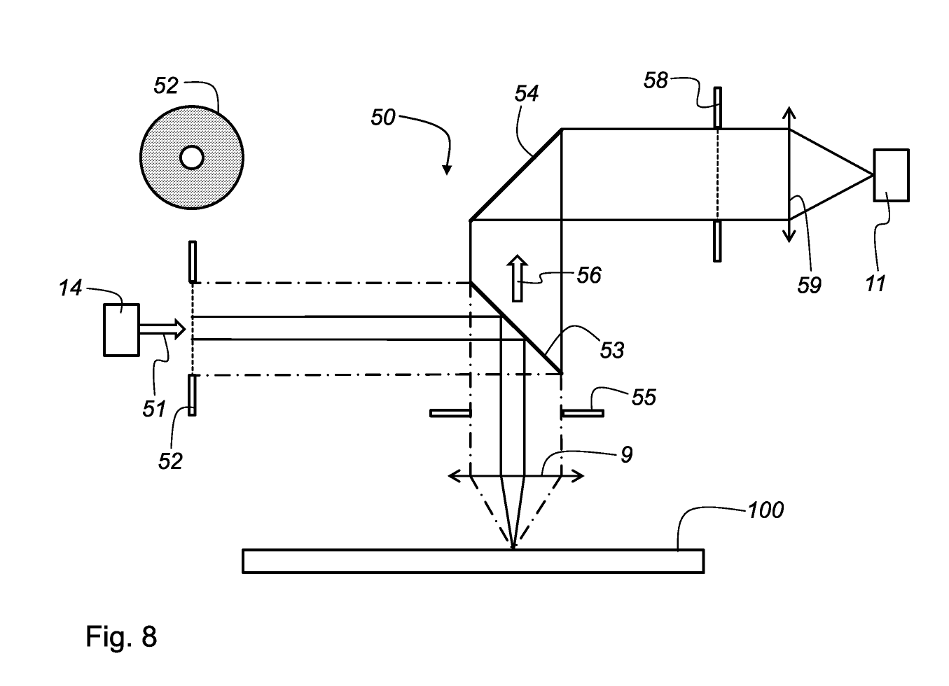

FIG. 8 is a schematic representation of another embodiment of an illumination and detection arrangement 50 which is used in conjunction with the coordinate measuring machine 1 for determining positions of defects 3 on EUV-masks blanks 100. The illumination and detection arrangement 50 includes the measurement objective 9 and tube lens 59. Unlike inspection devices where focus offset is of secondary importance, the coordinate measuring machine 1 needs to obtain accurate focus (de-focus) information at each point on the EUV-mask blank 100. To achieve this, the object of this invention uses a focus-offset generator module that allows for splitting the imaging field into a mosaic of images at different focus offsets. The contrast/signal-to-noise ratio of the defect signal may be increased by adding special amplitude and/or phase filters into an illumination pupil 52 and/or an imaging pupil 58. In this way it could be possible to increase the accuracy of the defect location and/or to reduce the detectable defect size.

The illumination and detection arrangement 50 has a first beam splitter 53 which directs light 51 from the light source 14 through the illumination pupil 52 and via the measuring objective 9 onto the object 100. A second beam splitter 54 of the illumination and detection arrangement 50 directs reflected light 56 from object 100 via an imaging pupil 58 and a tube lens 59 onto the detector array 11. Between the first beam splitter 53 and the measuring objective 9 a pupil 55 is provided. An amplitude filter (not shown) and/or a phase filter (not shown) are added to the illumination pupil and/or to the imaging pupil to increase contrast or signal-to-noise ratio of a defect signal which is generated by the detector array 11. It is evident that the illumination and detection arrangement 50 can be arranged such that only one beam splitter is necessary.

The computer 16 (see FIG. 7) has an algorithm implemented which uses the data from the detector 11 of the coordinate measuring machine 1 and the data, provided via the interface 40, from the inspection device 2. The phase defect 3 provides a signal via the detector array 11 at certain defocus positions. The defocus positions are set by the shifting device 15 which acts on the measuring objective 9. Each signal has to be detected and filtered. Taking images of the defect 3 at various defocus positions may result in signal-to-noise enhancement leading to the measurement capability on smaller (Smaller SEVD=spherical equivalent volume diameter) defects 3.

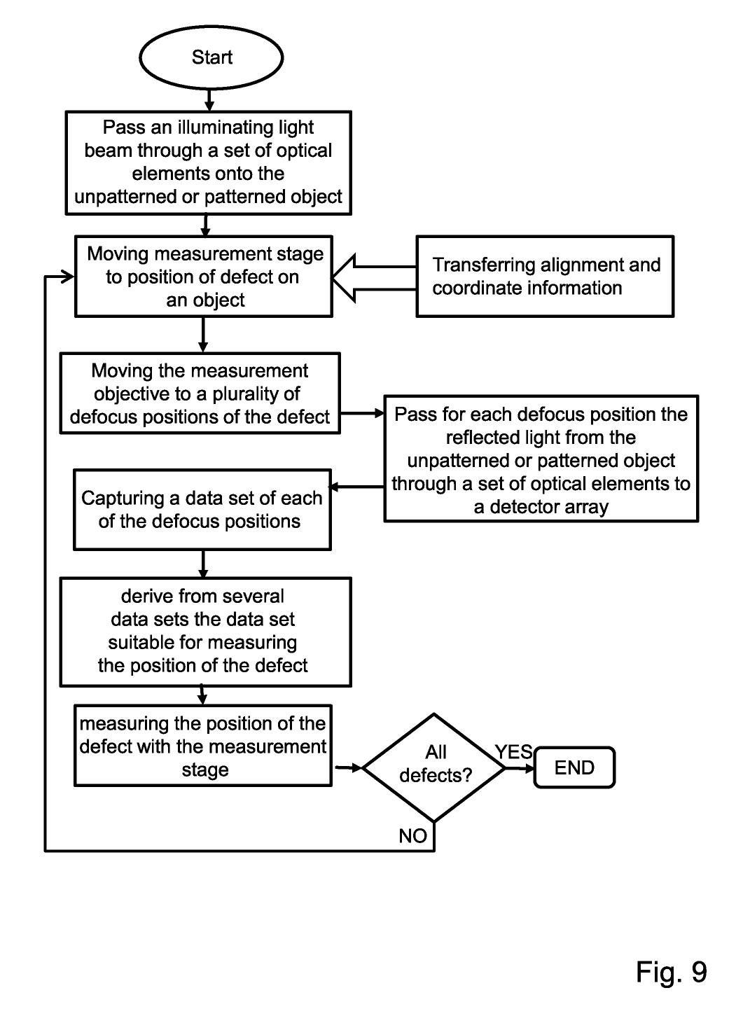

FIG. 9 is a flow chart of the inventive method to determine the location of a defect on an object 100. As mentioned above a light beam is passed through the set of optical elements of the illumination and detection arrangement 50 onto the object 100. With the transferred alignment and coordinate information the measuring stage 20 can be moved to the position of the defect on the unpatterned object 100. The quick positioning of the measuring stage 20 is such that the defect 3 whose position or location needs to be measured, with the required accuracy, is positioned within an imaging window of the detector array 11. Once the defect is positioned in the imaging window of the detector array 11 the measuring objective 9 is moved to a set of positions along the Z-coordinate direction in order to obtain a stack of data sets or images at different defocus positions. The detector array 11 captures a data set or an image at each of the defocus positions. Each data set or image is represented by I(x,y,f) which is the image intensity at pixel position (x,y), and defocus position f.

From the images at the various defocus positions an image data set is calculated which allows the measurement of the position of the defect at the required accuracy. An algorithm is applied which calculates an output w(x,y) of the matched filter g according to the equation below:

$$w ( x , y ) = {\sum }_{f} {\sum }_{{x}^{′} , {y}^{′}} I ( {x}^{′} - x , {y}^{′} - y , f ) g ( {x}^{′} , {y}^{′} , f )$$

The summation x′, y′ is over the pixels of the matched filter. The outer summation is over discrete focus values at which the image is acquired. In one embodiment, the image is acquired at only one defocus value and the outer summation over focus values is dropped. A defect is detected at the location (x,y) if |w(x,y)| exceeds a predetermined threshold. The matched filter is calculated according to the equation below from images obtained during a calibration stage:

g=(Cov[I_{noDefect}])^{#}I_{defect}

In the equation above I_{defect} is a column vector formed from the image I_{defect}(x,y,f). The pixel and focus indices are mapped to the column index. The image I_{defect}(x,y,f) is the image of a defect of interest. The defect of interest is either manufactured on purpose or it is a naturally occurring defect on a reticle. A defect can be manufactured by etching a pit or deposition a particle on a substrate. The substrate supporting the etched pit or deposited particle is then covered by an EUV multi-layer reflector. Cov[I_{noDefect}] is the covariance matrix of column vectors I_{noDefect}. Samples of I_{noDefect}(x,y,f) are acquired at locations known not to be defect-free. The symbol (.)^{#} indicates generalized inverse.

Once a defect is located by the algorithm, the coordinate measuring machine 1 begins with exact measurement of the location of the defect. After the finish of the measurement of the actual defect the measuring stage is moved to the next defect. This process is carried on until the position of the last defect in the object is measured.

The invention has been described with reference to specific embodiments. It is obvious to a person skilled in the art however alterations and modifications can be made without leaving the scope of the subsequent claims.

### REFERENCE NUMBERS

1 Coordinate measuring unit
2 Inspection unit
3 Defects
5 Reflected light beam path
9 Measuring objective
10 Camera
11 Detector array
12 Decoupling device
14 Light source (reflected light)
15 Shifting device
16 Computer
18 Focus-offset generator module
20 Measuring stage
21 Bearing
23 Measuring light beam
24 Length gauge
25 Block
25 A plane
26 Vibration absorbers
40 Interface
50 An illumination and detection arrangement
51 Light from light source
52 Illumination pupil
53 First beam splitter
54 Second beam splitter
55 Pupil
56 Reflected light
58 Imaging pupil
59 Tube lens
60 Climate chamber
62 Display
64 Input unit
65 Load port
100 Unpatterned object: EUV mask blank
102 Substrate
104 Multiple layers
106 Capping layer
112 Surface defect: pit
112 S-pit on substrate
114 Surface defect: bump
114 S-bump on substrate
116 Surface defect: particle
200 System
202 Flat portion
204 Pit
206 Bump
210 Reflected light from pit
211 Reflected light from bump
212 Reflected light from flat portion
D Depth
H Height
W Width
X X coordinate direction
Y Y coordinate direction
Z Z coordinate direction

What is claimed is:

1. A system for determining the position of defects on objects comprising:
an apparatus with coordinate measuring unit and an inspection unit for objects; and,
an interface for sending alignment and coordinate information from the inspection unit to the coordinate measuring unit.

2. The system of claim 1, wherein the coordinate measuring unit and the inspection unit are locally separated units, which are linked by the interface.

3. The system of claim 1, wherein the coordinate measuring unit comprises:
a measuring stage for moving the object in a X-coordinate direction and a Y-coordinate direction,
an illumination and detection arrangement with a light source for reflected light illumination of the object, a measuring objective and a detector array arranged for detecting an intensity of light reflected from the object and collected by the measuring objective;
a shifting device for moving the measuring objective along a Z coordinate direction in order to set different focus positions; and
a computer, receiving a data set from the detector array of at least one defect on the object at various focus positions and the alignment and coordinate information of the object from the inspection unit, adapted to calculate a position of the defect on the object.

4. The system of claim 3, wherein the light source of the illumination and detection arrangement is a laser light source for providing a light beam to illuminate the object with partially coherent light.

5. The system of claim 4, wherein the laser light source is a pulsed laser light source and the detector array is selected from the group consisting of: a CCD sensor for mitigating the effect of vibration and unwanted blur and a TDI sensor for continuous integration having a higher signal to noise ratio.

6. The system of claim 4, wherein the laser light source is a continuous wave laser light source and the detector array is selected from the group consisting of: a CCD sensor for mitigating the effect of vibration and unwanted blur and a TDI sensor for continuous integration having a higher signal to noise ratio.

7. The system of claim 3, wherein the illumination and detection arrangement has an illumination pupil which provides low sigma illumination setup which is smaller than 0.25.

8. The system of claim 3, wherein a beam splitter directs light from the light source through the illumination pupil, via the measuring objective onto the object and wherein reflected light from object reaches the detector via an imaging pupil and a tube lens.

9. The system of claim 7, wherein an amplitude filter and/or a phase filter are added to the illumination pupil and/or to the imaging pupil to increase contrast or signal-to-noise ratio of a defect signal generated by the detector array.

10. The system of claim 3, further comprising:
a climate chamber surrounds at least the coordinate measuring unit in order to control environmental parameters including temperature, pressure and air turbulence; and,
a length gauge for stage position measurement.

11. The system of claim 3, wherein the computer is arranged to calculate intensity values of a pixel position I(x,y) from a plurality of data sets or images taken by the measuring objective at various focus positions along the Z coordinate direction.

12. A method for determining the position of defects on objects comprising:
transferring alignment and coordinate information of at least one defect taken by an inspection unit to a coordinate measuring unit;
generating an illuminating light beam having a wavelength of less than approximately 250 nanometers;
positioning a measurement stage of the coordinate measuring unit according to the alignment and coordinate information transferred by the inspection unit;
illuminating the object with the illuminating light beam through a set of optical elements;
setting various defocus positions of a measuring objective along a Z coordinate direction and acquiring a data set or image at each Z-position with a detector array of a camera;
determining a phase defect from a plurality of data set or images captured at certain defocus positions, wherein a derivate data set or a derivate image is generated and the derivate data set or the derivate image set is filtered; and
measuring the position of the phase defect by measuring the position of the stage in the X-coordinate direction and the Y coordinate direction at high accuracy and high sampling rate through a length gauge.

13. The method of claim 12, wherein the measurement of the position of the phase defect is also determined via a center of gravity calculated from the derivate data set or the derivate image set.

14. The method of claim 12, wherein the illuminating light beam is generated by a laser light source for illuminating the object with partially coherent light.

15. The method of claim 14, wherein the laser light source is a pulsed laser light source.

16. The method of claim 14, wherein the laser light source is a continuous wave laser light source.

17. The method of claim 12, wherein the set of optical elements for illuminating the object provides low sigma illumination setup which is smaller than 0.25 for reflected light illumination.

18. The method of claim 12, wherein the set of optical elements comprises:
a measuring objective, movable in a Z-coordinate direction;
a detector array arranged to detect the intensity of light reflected from the object and collected by the measuring objective; and,
at least one beam splitter arranged to direct light from the light source via the measuring objective onto the object and to direct reflected light from the object via an imaging pupil and a tube lens onto the detector array.

19. The method of claim 12, wherein a climate chamber arranged to surround at least the coordinate measuring unit and to control environmental parameters such as temperature, pressure, and air turbulence that affect imaging conditions of the defect on the detector array and the measurement stage position measurement.

20. The method of claim 12, further comprising:
running an algorithm, implemented on a computer, to calculate from the intensity values I(x,y) for all pixel positions of a data set and for a plurality of images taken by the detector array with the measuring objective being positioned at various focus positions along the Z coordinate direction an image of the defect at a certain defocus position for measurement of the position and dimension of the defect on the object.

21. The method of claim 20, wherein the object is an EUV mask blank.

22. A coordinate measuring unit comprising:
a measuring stage for moving the object in a X-coordinate direction and an Y-coordinate direction and being equipped with at least one length gauge for measuring the position of a phase defect by measuring the position of the stage in the X-coordinate direction and the Y coordinate direction at high accuracy and high sampling rate;
an illumination and detection arrangement with a light source for reflected light illumination of the object, a measuring objective and a detector array arranged to detect an intensity of light reflected from the object and collected by the measuring objective;
a shifting device for moving the measuring objective along a Z coordinate direction in order to set different defocus positions; and
a computer arranged to receive a plurality of data sets from the detector array of at least one defect taken at various focus positions and to determine a data set from the various focus positions which is suitable for measuring a position of the defect on the object in the X-coordinate direction and the Y-coordinate direction.

23. The coordinate measuring unit of claim 22, wherein an interface is provided with the computer of the coordinate measuring unit for receiving alignment and coordinate information from an inspection unit.

24. The coordinate measuring unit of claim 22, wherein the light source of the illumination and detection arrangement is a laser light source arranged to emit a light beam to illuminate the object with partially coherent light.

25. The coordinate measuring unit of claim 24, wherein the laser light source is a pulsed laser light source.

26. The coordinate measuring unit of claim 24, wherein the laser light source is a continuous wave laser light source.

27. The coordinate measuring unit as defined in claim 22, wherein the light source of the illumination and detection arrangement comprises:
an illumination pupil arranged downstream from the light source; and,
at least one beam splitter is arranged such that light from the light source reaches via the measuring objective the object and wherein reflected light from object reaches via an imaging pupil and a tube lens onto the detector array.

28. The coordinate measuring unit as defined in claim 27, wherein illumination pupil of the illumination and detection arrangement which provides low sigma illumination setup which is smaller than 0.25.

29. The coordinate measuring unit as defined in claim 27, wherein an amplitude filter and/or a phase filter are added to the illumination pupil and/or to the imaging pupil to increase contrast or signal-to-noise ratio of a defect signal generate by the detector array.

30. The coordinate measuring unit as defined in claim 27, wherein a climate chamber surrounds the coordinate measuring machine in order to control environmental parameters such as temperature, pressure and air turbulence can affect the imaging conditions and an interferometric stage position measurement.

31. A computer program for coordinate measuring unit comprising:
setting the measurement objective to at least one defocus position with respect to an object;
taking at least one data set or image with a detector array at the at least one defocus position, wherein each data set or image is composed of a plurality of pixels each providing an intensity signal I(x,y,f) at the at least one defocus position;
applying a function;
providing an altered output image data set w(X,Y) of the least one defocus position;
detecting at last one defect at a location A Y on the object, if |w(X,Y)| exceeds a predetermined threshold; and
measuring a position of the at least one defect through a length gauge means which is in relation with a measuring stage of the coordinate measuring unit.

32. The computer program of claim 31, wherein the function is a filter.

33. The computer program of claim 32, wherein a plurality of data sets or images are taken by the detector array each at a different defocus position, applying the filter to each data set and determining the at least one defect from the plurality of altered output data sets.

34. The computer program of claim 32, wherein from the plurality of data sets or images a derivate data set or image is calculated and there from a center of gravity is determined, which is used to determine the position of the defect with the coordinate measuring unit.

35. The computer program of claim 31, wherein the altered data set w(X,Y) is calculated according to
$$w ( X , Y ) = {\sum }_{f} {\sum }_{{X}^{′} , {Y}^{′}} I ( {X}^{′} - X , {Y}^{′} - Y , f ) g ( {X}^{′} , {Y}^{′} , f ) ,$$
wherein the inner summation X′Y′ is over the pixels of the matches filter and the outer summation over discrete defocus values f.

36. The computer program of claim 31, wherein a matched filter is calculated according to g=(Cov[I_{noDefect}])^{#}I_{Defect} wherein I_{Defect} is a column vector formed from the image I_{defect}=(X,Y,f).

37. The computer program of claim 35, wherein pixel indices X, Y and the focus index f are mapped to the column index.

38. The computer program of claim 35, wherein Cov[I_{noDefect}] is a covariance matrix of column vectors.

39. The computer program of claim 31, wherein the function is a probability distribution function, which is determined during a training stage of a reference object which has several implanted and known phase defects.

40. The computer program of claim 39, wherein defects are detected on the object with a statistical method based on the learnt probability distribution function.

41. The computer program of claim 40, wherein the statistical method is a hypothesis testing.
